(19) United States
(12) Patent Application Publication
(10) Pub. No.: US 2024/0349099 A1
(43) Pub. Date: Oct. 17, 2024

(54) EARLY MEASUREMENT REPORTING DURING SMALL DATA TRANSMISSION

(71) Applicant: Nokia Technologies Oy, Espoo (FI)

(72) Inventors: Jussi-Pekka KOSKINEN, Oulu (FI); Tero HENTTONEN, Espoo (FI); Samuli Heikki TURTINEN, Oulu (FI)

(21) Appl. No.: 18/294,962

(22) PCT Filed: Aug. 17, 2021
(86) PCT No.: PCT/EP2021/072810

§ 371 Date: Feb. 2, 2024

(51) Int. Cl. H04W 24/10; H04W 76/27

(52) U.S. Cl. CPC H04W 24/10; H04W 76/27

(57) ABSTRACT

Systems, methods, apparatuses, and computer program products for early measurement reporting during small data transmission. A method may include receiving, from a network element, an early measurement reporting configuration. The method may also include receiving, from the network element, an indication of whether early measurement reporting during small data transmission is allowed. The method may further include initiating small data transmission to the network element. In addition, the small data transmission may include an early measurement reporting report when early measurement is allowed.

### FIELD

Some example embodiments may generally relate to mobile or wireless telecommunication systems, such as Long Term Evolution, LTE, or fifth generation, 5G new radio, NR, access technology, or other communications systems. For example, certain embodiments may relate to apparatuses, systems, and/or methods for early measurement reporting during small data transmission.

### BACKGROUND

Examples of mobile or wireless telecommunication systems may include the Universal Mobile Telecommunications System (UMTS) Terrestrial Radio Access Network, UTRAN, Long Term Evolution, LTE, Evolved UTRAN, E-UTRAN, LTE-Advanced, LTE-A, MulteFire, LTE-A Pro, and/or fifth generation, 5G, radio access technology or new radio (NR) access technology. 5G wireless systems refer to the next generation, NG, of radio systems and network architecture. 5G is mostly built on a new radio, NR, but the 5G (or NG) network can also build on E-UTRAN radio. It is estimated that NR will provide bitrates on the order of 10-20 Gbit/s or higher, and will support at least enhanced mobile broadband, eMBB, and ultra-reliable low-latency-communication, URLLC, as well as massive machine-type communication, mMTC. NR is expected to deliver extreme broadband and ultra-robust, low-latency connectivity and massive networking to support the Internet of Things, IoT.

### SUMMARY

Some example embodiments are directed to a method. The method may include receiving, from a network element, an early measurement reporting configuration. The method may also include receiving, from the network element, an indication of whether early measurement reporting during small data transmission is allowed. The method may further include initiating small data transmission to the network element. According to certain example embodiments, the small data transmission may include an early measurement reporting report when early measurement reporting is allowed.

Other example embodiments are directed to an apparatus that may include at least one processor and at least one memory including computer program code. The at least one memory and the computer program code are configured, with the at least one processor to cause the apparatus at least to receive, from a network element, an early measurement reporting configuration. The apparatus may also be caused to receive, from the network element, an indication of whether early measurement reporting during small data transmission is allowed. The apparatus may further be caused to, initiate small data transmission to the network element. According to certain example embodiments, the small data transmission may include an early measurement reporting report when early measurement reporting is allowed.

Other example embodiments are directed to an apparatus. The apparatus may include means for receiving, from a network element, an early measurement reporting configuration. The apparatus may also include means for receiving, from the network element, an indication of whether early measurement reporting during small data transmission is allowed. The apparatus may further include, initiating small data transmission to the network element. According to certain example embodiments, the small data transmission may include an early measurement reporting report when early measurement reporting is allowed.

In accordance with other example embodiments, a non-transitory computer readable medium may be encoded with instructions that may, when executed in hardware, perform a method. The method may include receiving, from a network element, an early measurement reporting configuration. The method may also include receiving, from the network element, an indication of whether early measurement reporting during small data transmission is allowed. The method may further include initiating small data transmission to the network element. According to certain example embodiments, the small data transmission may include an early measurement reporting report when early measurement reporting is allowed.

Other example embodiments may be directed to a computer program product that performs a method. The method may include receiving, from a network element, an early measurement reporting configuration. The method may also include receiving, from the network element, an indication of whether early measurement reporting during small data transmission is allowed. The method may further include initiating small data transmission to the network element. According to certain example embodiments, the small data transmission may include an early measurement reporting report when early measurement reporting is allowed.

Other example embodiments may be directed to an apparatus that may include circuitry configured to receive, from a network element, an early measurement reporting configuration for small data transmission. The apparatus may also include circuitry configured to receive, from the network element, an indication of whether early measurement reporting during small data transmission is allowed. The apparatus may further include circuitry configured to, when early measurement reporting is allowed, initiate small data transmission to the network element. In addition, the apparatus may include circuitry configured to transmit a subsequent small data transmission to the network element. According to certain example embodiments, the initial small data transmission or the subsequent small data transmission may include an early measurement reporting report.

Certain example embodiments may be directed to a method. The method may include transmitting an early measurement reporting configuration to a user equipment. The method may also include transmitting, to the user equipment an indication of whether early measurement reporting during small data transmission is allowed. The method may further include receiving a small data transmission from the user equipment. According to certain example embodiments, the small data transmission may include an early measurement reporting report when early measurement reporting is allowed.

Other example embodiments may be directed to an apparatus. The apparatus may include at least one processor and at least one memory including computer program code. The at least one memory and computer program code may be configured to, with the at least one processor, cause the apparatus at least to transmit an early measurement reporting configuration to a user equipment. The apparatus may also be caused to transmit, to the user equipment an indication of whether early measurement reporting during small data transmission is allowed. The apparatus may further be caused to, receive a small data transmission from the user equipment. According to certain example embodiments, the small data transmission may include an early measurement reporting report when early measurement reporting is allowed.

Other example embodiments may be directed to an apparatus. The apparatus may include means for transmitting an early measurement reporting configuration to a user equipment. The apparatus may also include means for transmitting, to the user equipment an indication of whether early measurement reporting during small data transmission is allowed. The apparatus may further include means for receiving small data transmission from the user equipment. According to certain example embodiments, the small data transmission may include an early measurement reporting report when early measurement reporting is allowed.

In accordance with other example embodiments, a non-transitory computer readable medium may be encoded with instructions that may, when executed in hardware, perform a method. The method may include transmitting an early measurement reporting configuration to a user equipment. The method may also include transmitting, to the user equipment an indication of whether early measurement reporting during small data transmission is allowed. The method may further include receiving a small data transmission from the user equipment. According to certain example embodiments, the small data transmission may include an early measurement reporting report when early measurement reporting is allowed.

Other example embodiments may be directed to a computer program product that performs a method. The method may include transmitting an early measurement reporting configuration to a user equipment. The method may also include transmitting, to the user equipment an indication of whether early measurement reporting during small data transmission is allowed. The method may further include receiving a small data transmission from the user equipment. According to certain example embodiments, the small data transmission may include an early measurement reporting report when early measurement reporting is allowed.

Other example embodiments may be directed to an apparatus that may include circuitry configured to transmit an early measurement reporting configuration to a user equipment. The apparatus may also include circuitry configured to transmit, to the user equipment an indication of whether early measurement reporting during small data transmission is allowed. The apparatus may further include circuitry configured to receive a small data transmission from the user equipment. According to certain example embodiments, the small data transmission may include an early measurement reporting report when early measurement reporting is allowed.

### BRIEF DESCRIPTION OF THE DRAWINGS

For proper understanding of example embodiments, reference should be made to the accompanying drawings, wherein:

FIG. 1 illustrates an example signal flow diagram, according to certain example embodiments.

FIG. 2 illustrates a flow diagram of a method, according to certain example embodiments.

FIG. 3 illustrates a flow diagram of another method, according to certain example embodiments.

FIG. 4(a) illustrates an apparatus, according to certain example embodiments.

FIG. 4(b) illustrates another apparatus, according to certain example embodiments.

### DETAILED DESCRIPTION

It will be readily understood that the components of certain example embodiments, as generally described and illustrated in the figures herein, may be arranged and designed in a wide variety of different configurations. The following is a detailed description of some example embodiments of systems, methods, apparatuses, and computer program products for early measurement reporting (EMR) during small data transmission (SDT) procedure.

The features, structures, or characteristics of example embodiments described throughout this specification may be combined in any suitable manner in one or more example embodiments. For example, the usage of the phrases “certain embodiments,” “an example embodiment,” “some embodiments,” or other similar language, throughout this specification refers to the fact that a particular feature, structure, or characteristic described in connection with an embodiment may be included in at least one embodiment. Thus, appearances of the phrases “in certain embodiments,” “an example embodiment,” “in some embodiments,” “in other embodiments,” or other similar language, throughout this specification do not necessarily all refer to the same group of embodiments, and the described features, structures, or characteristics may be combined in any suitable manner in one or more example embodiments. Further, the phrase “based on” may indicate a condition and/or situation. For example, “based on” may mean “if”, and “based on” may be interchangeable with the conditional word “if”.

Additionally, if desired, the different functions or steps discussed below may be performed in a different order and/or concurrently with each other. Furthermore, if desired, one or more of the described functions or steps may be optional or may be combined. As such, the following description should be considered as merely illustrative of the principles and teachings of certain example embodiments, and not in limitation thereof.

3^{rd} Generation Partnership Project (3GPP) specifications provide certain ways to avoid signaling overhead and delay with transition for radio resource control (RRC) INACTIVE state to RRC_CONNECTED state to perform SDT. Further, 3GPP work time item provides both random access channel-based (RACH-based) SDT and configured grant-SDT (CG-SDT) as objectives. For RRC_INACTIVE state, uplink (UL) SDTs for RACH-based schemes (i.e., 2-step and 4-step RACH) may be provided. for instance, a general procedure may enable user plane (UP) or control plane (CP) data transmission for small data packets from the INACTIVE state. UL SDT may also enable flexible payload sizes larger than the 3GPP common control channel (CCCH) message size that is possible currently for INACTIVE state for a single message (MSGA) and MSG3 to support UP/CPdata transmission in UL (actual payload size may be up to network configuration). Additionally, in UL SDT, context fetch and data forwarding (with and without anchor relocation) in INACTIVE state for RACH-based solutions may be provided.

In some cases, transmission of UL data on pre-configured physical uplink shared channel (PUSCH) resources (i.e., reusing the configured grant type 1) may occur when timing advance (TA) is valid. For instance, transmission of UL data on pre-configured PUSCH resources may be applicable for general procedure for SDT over configured grant type 1 resources from the INACTIVE state. In addition, it may be applicable for configuration of the configured grant type 1 resources for SDT in UL for the INACTIVE state.

In 3GPP, subsequent uplink/downlink (UL/DL) transmission may follow initial UL SDT without transitioning to RRC_CONNECTED state. Further, when the user equipment (UE) is in RRC_INACTIVE state, it may be possible to send multiple UL and DL packets as part of the same SDT mechanism, and without transitioning to RRC_CONNECTED on dedicated grant(s). Additionally, in RAN2 design, it may be assumed that RRCRelease message is sent at the end to terminate the SDT procedure from the RRC point of view. In addition, the RRCRelease sent at the end of the SDT may include the configured grant (CG) resource.

In 3GPP, the UE and the network (NW) may transfer more than one data back in the UL and DL during an SDT procedure. This may be beneficial as the size of the msg 3 may be limited. It may also allow the data to be segmented to be sent over multiple transport blocks (TBs) if the packet data convergence protocol (PDCP) service data unit (SDU) size is too large to fit in one TB. Furthermore, multiple DL packets in 3GPP may be transmitted by the NW as part of the same SDT procedure without transitioning to RRC_CONNECTED state. Such multiple DL transmissions may be scheduled before the DL RRC message, which may be used for integrity verification, is transmitted.

In 3GPP, the NW may transit the UE to RRC_CONNECTED state during an SDT procedure by transmitting an RRCResume message to the UE. However, this may result in a problem where it may not be possible for the UE to provide measurement results to the NW before the RRC Resume message is received by the UE. This means that the NW may not be aware of what kind of carrier aggregation (CA) or dual connectivity (DC) configuration would be optimal to configure for the UE in the RRCResume message. Thus, the UE may only include the available measurement results in the RRCResumeComplete message, and the NW may then need to perform another RRC reconfiguration procedure for proper measurement or CA/DC configuration for the UE.

In 3GPP, the UE may be configured to perform measurements in IDLE/INACTIVE while a timer is running. These are often referred to as Early Measurement Reporting (EMR). The network may request the UE to measure NR and/or Evolved Universal Terrestrial Radio Access (E-UTRA) carriers in RRC_IDLE state or RRC_INACTIVE state via dedicated measurement configuration in RRC Release. If the UE was configured to perform measurements or NR and/or E-UTRA carriers while in RRC_IDLE state, it may provide an indication of the availability of corresponding measurement results to the gNB in the RRCSetupComplete message. Further, the network may request the UE to report those measurements after security activation. The request for the measurements may be sent by the NW immediately after transmitting the Security Mode Command (i.e., before the reception of the Security Mode Complete from the UE). If the UE was configured to perform measurements of NR and/or E-UTRA carriers while in RRC_INACTIVE state, the gNB may request the UE to provide corresponding measurement results in the RRCResume message, and then the UE may include the available measurement results in the RRCResumeComplete message. Alternatively, the UE may provide an indication of the availability of the measurement results to the gNB in the RRCResumeComplete message, and the gNB may then request the UE to provide these measurement results after Security Mode Complete in the same manner as for UEs becoming RRC_CONNECTED from RRC_IDLE.

Certain example embodiments may provide a mechanism for the UE to provide measurement results of serving/neighbor cells during initial or subsequent SDT transmission so that optimal CA/DC may already be configured in the first RRCResume message. For instance, in some example embodiments, the UE may transmit an EMR report during an SDT procedure. In other example embodiments, the EMR report may be triggered during the SDT procedure by the UE if one or more signaling radio bearers (SRBs) are configured for SDT, and/or EMR reporting is configured for the SDT procedure.

According to certain example embodiments, the UE may start or continue neighbor cell (e.g., EMR) measurements during the SDT procedure, and report the measurement results when the UE is ready/available (e.g., this may include indicating ongoing EMR procedure during the SDT transmission so that the network knows the UE is performing the measurements). According to some example embodiments, the UE may report measurement results during the SDT procedure if certain conditions are met. In certain example embodiments, the conditions may, for example, be referenced to received power/reference signal received quality (RSRP/RSRQ). For example, with regard to RSRP/RSRQ, the UE may report cells that are better than a threshold or are within an offset from the serving cell measurement, based on network configuration or determined by the UE.

In certain example embodiments, the NW may request an EMR report during the SDT procedure. Such a request may be performed, for example, using physical layer/medium access control/radio resource control (PHY/MAC/RRC) signaling (e.g., UEInformationRequest message). In other example embodiments, an existing EMR report may be transmitted using UEInformationResponse (which may also be without the NW sending prior UEInformationRequest) when the EMR data is ready. In some example embodiments, a UEAssistanceInformation message may be used for providing EMR results during the SDT procedure. In some other example embodiments, another RRC message may be used for providing EMR results during SDT procedure.

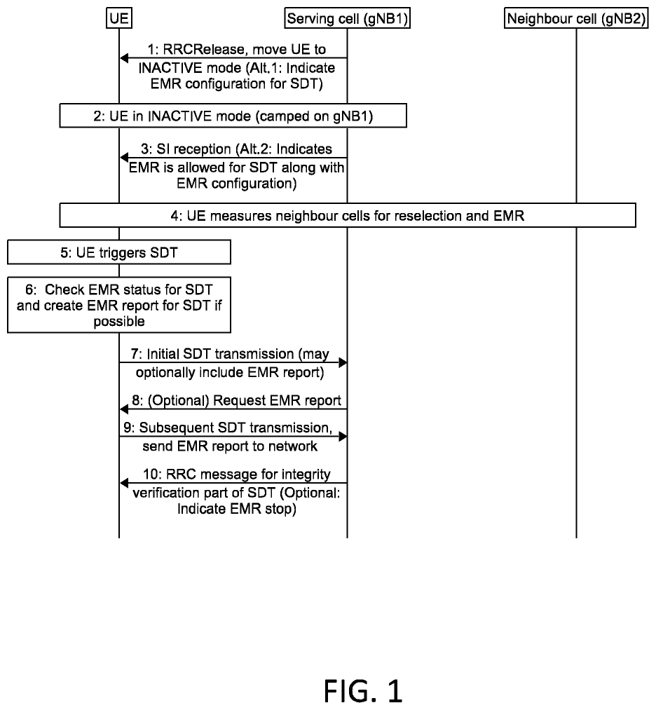

FIG. 1 illustrates an example signal flow diagram according to certain example embodiments. In particular, FIG. 1 illustrates an example signal flow diagram of an EMR reporting procedure during SDT transmission, according to certain example embodiments. At 1, the UE may be moved to INACTIVE mode. In certain example embodiments, the UE may also be indicated whether EMR for SDT is allowed. This may be done, for example as part of the SDT configuration, or as part of the EMR configuration. At 2, the UE may be in INACTIVE mode, and camped on gNB1 where SDT is allowed. At 3, the UE may receive system information from the serving cell. Additionally, in certain example embodiments, the UE may be indicated, as part of system information (SI), whether EMR for SDT is allowed along with EMR configuration.

As further illustrated in FIG. 1, at 4, the UE may perform measurements for cell reselection and EMR. At 5, the UE may trigger SDT transmission, and at 6, the UE may check whether EMR for SDT has measurements to report. If there are measurements to report, the UE may create an EMR report for transmission via SDT. At 7, the UE may initiate SDT transmission. According to certain example embodiments, this operation may already include the EMR report. At 8, the network may optionally request the UE to send the EMR report. At 9, the UE may send a subsequent SDT transmission to the network, and may also include an EMR report in the SDT transmission. At 10, the UE may receive an RRC message prompting an integrity check for SDT. In some example embodiments, this operation may also indicate the UE to stop EMR measurements.

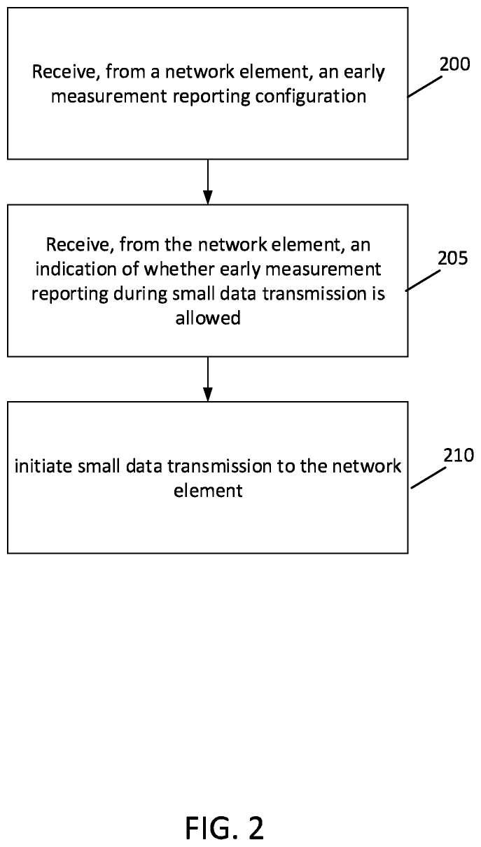

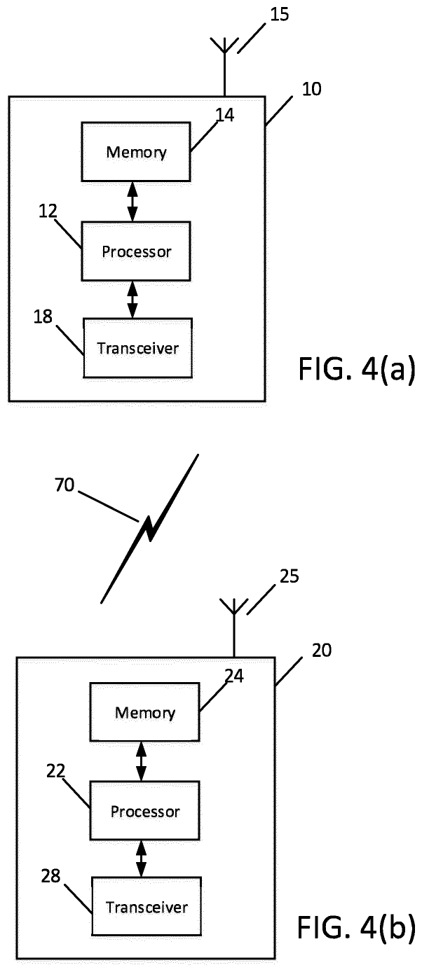

FIG. 2 illustrates a flow diagram of a method, according to certain example embodiments. In some example embodiments, the flow diagram of FIG. 2 may be performed by a telecommunications network entity or network node in a 3GPP system, such as LTE or 5G-NR. For instance, in certain example embodiments, the method of FIG. 2 may be performed by a UE, for instance similar to apparatuses 10 or 20 illustrated in FIG. 4(a) or 4(b).

According to certain example embodiments, the method of FIG. 2 may include, at 200, receiving, from a network element, an early measurement reporting configuration. At 205, the method may also include receiving, from the network element, an indication of whether early measurement reporting during small data transmission is allowed. At 210, the method may include, initiate small data transmission to the network element. According to certain example embodiments, the small data transmission may include an early measurement reporting report when early measurement reporting is allowed.

According to certain example embodiments, the early measurement reporting report may be included in one or more of initial small data transmission or subsequent small data transmission. According to other example embodiments, the initial small data transmission may include a radio resource control message for small data transmission. According to some example embodiments, the subsequent small data transmission may be performed after the one or more initial small data transmission. According to certain example embodiments, the method may also include performing measurements of neighbor cells or serving cellsfor reselection and early measurement reporting. According to some example embodiments, initiation of the initial small data transmission may include starting a small data transmission procedure by transmitting an initial small data transmission message. According to other example embodiments, transmission of the early measurement reporting report may be triggered when one or more signaling radio bearers are configured for small data transmission, or when early measurement reporting is configured for small data transmission.

In certain example embodiments, transmission of the early measurement reporting report may be performed when one or more conditions are satisfied. In some example embodiments, the method may further include receiving a request from the network element to send the early measurement reporting report. In other example embodiments, the radio resource control message may prompt an integrity check for the small data transmission. According to certain example embodiments, the radio resource control message may include an indication to stop early measurement reporting measurements.

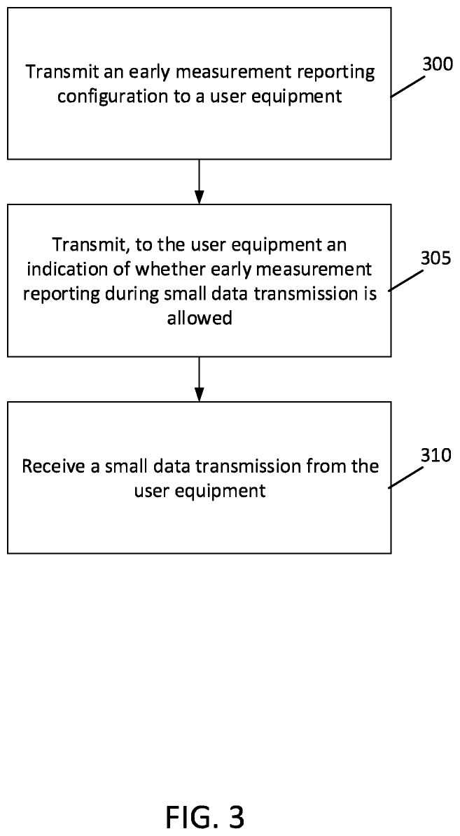

FIG. 3 illustrates a flow diagram of another method, according to certain example embodiments. In an example embodiment, the method of FIG. 3 may be performed by a telecommunications network entity or network node in a 3GPP system, such as LTE or 5G-NR. For instance, in certain example embodiments, the method of FIG. 3 may be performed by a gNB, for instance similar to apparatuses 10 or 20 illustrated in FIG. 4(a) or 4(b).

According to certain example embodiments, the method of FIG. 9 may include, at 300, transmitting an early measurement reporting configuration to a user equipment. At 305, the method may include transmitting, to the user equipment an indication of whether early measurement reporting during small data transmission is allowed. At 310, the method may include receiving a small data transmission from the user equipment. According to certain example embodiments, the small data transmission may include an early measurement reporting report when early measurement reporting is allowed.

According to certain example embodiments, the early measurement reporting report may be included in one or more initial small data transmission or subsequent small data transmission. According to some example embodiments, the initial small data transmission may include a radio resource control message for small data transmission. According to other example embodiments, the subsequent small data transmission may be performed after the one or more initial small data transmission. In some example embodiments, the method may also include transmitting a request to the user equipment requesting a small data transmission report. According to other example embodiments, the radio resource control message may prompt an integrity check for the small data transmission. In certain example embodiments, the radio resource control message may include an indication to stop early measurement reporting measurements.

FIG. 4(a) illustrates an apparatus 10 according to certain example embodiments. In an embodiment, apparatus 10 may be a network element in a communications network or associated with such a network, such as a UE, or other similar device. It should be noted that one of ordinary skill in the art would understand that apparatus 20 may include components or features not shown in FIG. 4(a).

In some example embodiments, apparatus 10 may include one or more processors, one or more computer-readable storage medium (for example, memory, storage, or the like), one or more radio access components (for example, a modem, a transceiver, or the like), and/or a user interface. In some embodiments, apparatus 10 may be configured to operate using one or more radio access technologies, such as GSM, LTE, LTE-A, NR, 5G, WLAN, WiFi, NB-IoT, Bluetooth, NFC, MulteFire, and/or any other radio access technologies. It should be noted that one of ordinary skill in the art would understand that apparatus 10 may include components or features not shown in FIG. 4(a).

As illustrated in the example of FIG. 4(a), apparatus 10 may include or be coupled to a processor 12 for processing information and executing instructions or operations. Processor 12 may be any type of general or specific purpose processor. In fact, processor 12 may include one or more of general-purpose computers, special purpose computers, microprocessors, digital signal processors, DSPs, field-programmable gate arrays, FPGAs, application-specific integrated circuits, ASICs, and processors based on a multi-core processor architecture, as examples. While a single processor 12 is shown in FIG. 4(a), multiple processors may be utilized according to other embodiments. For example, it should be understood that, in certain example embodiments, apparatus 10 may include two or more processors that may form a multiprocessor system, for example in this case processor 12 may represent a multiprocessor, that may support multiprocessing. According to certain example embodiments, the multiprocessor system may be tightly coupled or loosely coupled, for example to form a computer cluster.

Processor 12 may perform functions associated with the operation of apparatus 10 including, as some examples, precoding of antenna gain/phase parameters, encoding and decoding of individual bits forming a communication message, formatting of information, and overall control of the apparatus 10, including processes illustrated in FIGS. 1 and 2.

Apparatus 10 may further include or be coupled to a memory 14 (internal or external), which may be coupled to processor 12, for storing information and instructions that may be executed by processor 12. Memory 14 may be one or more memories and of any type suitable to the local application environment, and may be implemented using any suitable volatile or nonvolatile data storage technology such as a semiconductor-based memory device, a magnetic memory device and system, an optical memory device and system, fixed memory, and/or removable memory. For example, memory 14 can be comprised of any combination of random access memory, RAM, read only memory, ROM, static storage such as a magnetic or optical disk, hard disk drive, HDD, or any other type of non-transitory machine or computer readable media. The instructions stored in memory 14 may include program instructions or computer program code that, when executed by processor 12, enable the apparatus 10 to perform tasks as described herein.

In an embodiment, apparatus 10 may further include or be coupled to (internal or external) a drive or port that is configured to accept and read an external computer readable storage medium, such as an optical disc, USB drive, flash drive, or any other storage medium. For example, the external computer readable storage medium may store a computer program or software for execution by processor 12 and/or apparatus 10 to perform any of the methods illustrated in FIGS. 1 and 2.

In some embodiments, apparatus 10 may also include or be coupled to one or more antennas 15 for receiving a downlink signal and for transmitting via an uplink from apparatus 10. Apparatus 10 may further include a transceiver 18 configured to transmit and receive information. The transceiver 18 may also include a radio interface, for example, a modem, coupled to the antenna 15. The radio interface may correspond to a plurality of radio access technologies including one or more of GSM, LTE, LTE-A, 5G, NR, WLAN, NB-IoT, Bluetooth, BT-LE, NFC, RFID, UWB, and the like. The radio interface may include other components, such as filters, converters (for example, digital-to-analog converters and the like), symbol demappers, signal shaping components, an Inverse Fast Fourier Transform, IFFT, module, and the like, to process symbols, such as OFDMA symbols, carried by a downlink or an uplink.

For instance, transceiver 18 may be configured to modulate information on to a carrier waveform for transmission by the antenna(s) 15 and demodulate information received via the antenna(s) 15 for further processing by other elements of apparatus 10. In other embodiments, transceiver 18 may be capable of transmitting and receiving signals or data directly. Additionally or alternatively, in some embodiments, apparatus 10 may include an input and/or output device (I/O device). In certain embodiments, apparatus 10 may further include a user interface, such as a graphical user interface or touchscreen.

In an embodiment, memory 14 stores software modules that provide functionality when executed by processor 12. The modules may include, for example, an operating system that provides operating system functionality for apparatus 10. The memory may also store one or more functional modules, such as an application or program, to provide additional functionality for apparatus 10. The components of apparatus 10 may be implemented in hardware, or as any suitable combination of hardware and software. According to an example embodiment, apparatus 10 may optionally be configured to communicate with apparatus 20 via a wireless or wired communications link 70 according to any radio access technology, such as NR.

According to certain example embodiments, processor 12 and memory 14 may be included in or may form a part of processing circuitry or control circuitry. In addition, in some embodiments, transceiver 18 may be included in or may form a part of transceiving circuitry.

As discussed above, according to certain example embodiments, apparatus 10 may be a UE for example. According to certain embodiments, apparatus 10 may be controlled by memory 14 and processor 12 to perform the functions associated with example embodiments described herein. For instance, in certain example embodiments, apparatus 10 may be controlled by memory 14 and processor 12 to receive, from a network element, an early measurement reporting configuration. Apparatus 10 may also be controlled by memory 14 and processor 12 to receive, from the network element, an indication of whether early measurement reporting during small data transmission is allowed. Apparatus 10 may further be controlled by memory 14 and processor 12 to, initiate small data transmission to the network element. According to certain example embodiments, the small data transmission may include an early measurement reporting report when early measurement reporting is allowed.

FIG. 4(b) illustrates an apparatus 20 according to certain example embodiments. In an example embodiment, the apparatus 20 may be a network element in a communications network or associated with such a network, such as a gNB, or other similar device. It should be noted that one of ordinary skill in the art would understand that apparatus 20 may include components or features not shown in FIG. 4(b).

As illustrated in the example of FIG. 4(b), apparatus 20 may include a processor 22 for processing information and executing instructions or operations. Processor 22 may be any type of general or specific purpose processor. For example, processor 22 may include one or more of general-purpose computers, special purpose computers, microprocessors, DSPs, FPGAs, ASICs, and processors based on a multi-core processor architecture, as examples. While a single processor 22 is shown in FIG. 4(b), multiple processors may be utilized according to other embodiments. For example, it should be understood that, in certain embodiments, apparatus 20 may include two or more processors that may form a multiprocessor system (e.g., in this case processor 22 may represent a multiprocessor) that may support multiprocessing. In certain embodiments, the multiprocessor system may be tightly coupled or loosely coupled (e.g., to form a computer cluster.

According to certain example embodiments, processor 22 may perform functions associated with the operation of apparatus 20, which may include, for example, precoding of antenna gain/phase parameters, encoding and decoding of individual bits forming a communication message, formatting of information, and overall control of the apparatus 20, including processes illustrated in FIGS. 1 and 3.

Apparatus 20 may further include or be coupled to a memory 24 (internal or external), which may be coupled to processor 22, for storing information and instructions that may be executed by processor 22. Memory 24 may be one or more memories and of any type suitable to the local application environment, and may be implemented using any suitable volatile or nonvolatile data storage technology such as a semiconductor-based memory device, a magnetic memory device and system, an optical memory device and system, fixed memory, and/or removable memory. For example, memory 24 can be comprised of any combination of RAM, ROM, static storage such as a magnetic or optical disk, HDD, or any other type of non-transitory machine or computer readable media. The instructions stored in memory 24 may include program instructions or computer program code that, when executed by processor 22, enable the apparatus 20 to perform tasks as described herein.

In an embodiment, apparatus 20 may further include or be coupled to (internal or external) a drive or port that is configured to accept and read an external computer readable storage medium, such as an optical disc, USB drive, flash drive, or any other storage medium. For example, the external computer readable storage medium may store a computer program or software for execution by processor 22 and/or apparatus 20 to perform the methods illustrated in FIGS. 1 and 3.

In certain example embodiments, apparatus 20 may also include or be coupled to one or more antennas 25 for transmitting and receiving signals and/or data to and from apparatus 20. Apparatus 20 may further include or be coupled to a transceiver 28 configured to transmit and receive information. The transceiver 28 may include, for example, a plurality of radio interfaces that may be coupled to the antenna(s) 25. The radio interfaces may correspond to a plurality of radio access technologies including one or more of GSM, NB-IoT, LTE, 5G, WLAN, Bluetooth, BT-LE, NFC, RFID, UWB, MulteFire, and the like. The radio interface may include components, such as filters, converters (for example, digital-to-analog converters and the like), mappers, a FFT module, and the like, to generate symbols for a transmission via one or more downlinks and to receive symbols, for example, via an uplink.

As such, transceiver 28 may be configured to modulate information on to a carrier waveform for transmission by the antenna(s) 25 and demodulate information received via the antenna(s) 25 for further processing by other elements of apparatus 20. In other embodiments, transceiver 18 may be capable of transmitting and receiving signals or data directly. Additionally or alternatively, in some embodiments, apparatus 20 may include an input and/or output device (I/O device).

In an embodiment, memory 24 may store software modules that provide functionality when executed by processor 22. The modules may include, for example, an operating system that provides operating system functionality for apparatus 20. The memory may also store one or more functional modules, such as an application or program, to provide additional functionality for apparatus 20. The components of apparatus 20 may be implemented in hardware, or as any suitable combination of hardware and software.

According to some embodiments, processor 22 and memory 24 may be included in or may form a part of processing circuitry or control circuitry. In addition, in some embodiments, transceiver 28 may be included in or may form a part of transceiving circuitry.

As used herein, the term “circuitry” may refer to hardware-only circuitry implementations, for example analog and/or digital circuitry, combinations of hardware circuits and software, combinations of analog and/or digital hardware circuits with software/firmware, any portions of hardware processor(s) with software (including digital signal processors) that work together to cause an apparatus (e.g., apparatus 10 and 20) to perform various functions, and/or hardware circuit(s) and/or processor(s), or portions thereof, that use software for operation but where the software may not be present when it is not needed for operation. As a further example, as used herein, the term “circuitry” may also cover an implementation of merely a hardware circuit or processor (or multiple processors), or portion of a hardware circuit or processor, and its accompanying software and/or firmware. The term circuitry may also cover, for example, a baseband integrated circuit in a server, cellular network node or device, or other computing or network device.

As introduced above, in certain embodiments, apparatus 20 may be a be a network element, a node, host, or server in a communication network or serving such a network. For example, apparatus 20 may be a gNB, or other similar device associated with a RAN, such as an LTE network, 5G or NR. According to certain embodiments, apparatus 20 may be controlled by memory 24 and processor 22 to perform the functions associated with any of the embodiments described herein.

For instance, in one embodiment, apparatus 20 may be controlled by memory 24 and processor 22 to transmit an early measurement reporting configuration to a user equipment. Apparatus 20 may also be controlled by memory 24 and processor 22 to transmit, to the user equipment an indication of whether early measurement reporting during small data transmission is allowed. Apparatus 20 may further be controlled by memory 24 and processor 22 to receive a small data transmission from the user equipment. According to certain example embodiments, the small data transmission may include an early measurement reporting report when early measurement reporting is allowed.

In some example embodiments, an apparatus (e.g., apparatus 10 and/or apparatus 20) may include means for performing a method, a process, or any of the variants discussed herein. Examples of the means may include one or more processors, memory, controllers, transmitters, receivers, and/or computer program code for causing the performance of the operations.

Further example embodiments may provide means for performing any of the functions or procedures described herein. For example, certain example embodiments may be directed to an apparatus that includes means for receiving, from a network element, an early measurement reporting configuration. The apparatus may also include means for receiving, from the network element, an indication of whether early measurement reporting during small data transmission is allowed. The apparatus may further include means for initiating small data transmission to the network element. According to certain example embodiments, the small data transmission may include the early measurement reporting report when early measurement reporting is allowed.

Other example embodiments may be directed to a further apparatus that includes means for transmitting an early measurement reporting configuration to a user equipment. The apparatus may also include means for transmitting, to the user equipment an indication of whether early measurement reporting during small data transmission is allowed. The apparatus may further include means for receiving a small data transmission from the user equipment. According to certain example embodiments, the small data transmission may include an early measurement reporting report when early measurement reporting is allowed.

Certain example embodiments described herein provide several technical improvements, enhancements, and/or advantages. In some example embodiments, it may be possible for the UE to provide measurement results before RRC Resume as part of the SDT process. In other example embodiments, it may be possible for the NW to configure proper CA or DC configuration in the RRC Resume message based on reported measurements. In further example embodiments, it may be possible for the UE to continue with SDT while the NW processes the EMR report.

A computer program product may comprise one or more computer-executable components which, when the program is run, are configured to carry out some example embodiments. The one or more computer-executable components may be at least one software code or portions of it. Modifications and configurations required for implementing functionality of an example embodiment may be performed as routine(s), which may be implemented as added or updated software routine(s). Software routine(s) may be downloaded into the apparatus.

As an example, software or a computer program code or portions of it may be in a source code form, object code form, or in some intermediate form, and it may be stored in some sort of carrier, distribution medium, or computer readable medium, which may be any entity or device capable of carrying the program. Such carriers may include a record medium, computer memory, read-only memory, photoelectrical and/or electrical carrier signal, telecommunications signal, and software distribution package, for example. Depending on the processing power needed, the computer program may be executed in a single electronic digital computer or it may be distributed amongst a number of computers. The computer readable medium or computer readable storage medium may be a non-transitory medium.

In other example embodiments, the functionality may be performed by hardware or circuitry included in an apparatus (e.g., apparatus 10 or apparatus 20), for example through the use of an application specific integrated circuit, ASIC, a programmable gate array, PGA, a field programmable gate array, FPGA, or any other combination of hardware and software. In yet another example embodiment, the functionality may be implemented as a signal, a non-tangible means that can be carried by an electromagnetic signal downloaded from the Internet or other network.

According to an example embodiment, an apparatus, such as a node, device, or a corresponding component, may be configured as circuitry, a computer or a microprocessor, such as single-chip computer element, or as a chipset, including at least a memory for providing storage capacity used for arithmetic operation and an operation processor for executing the arithmetic operation.

One having ordinary skill in the art will readily understand that the invention as discussed above may be practiced with steps in a different order, and/or with hardware elements in configurations which are different than those which are disclosed. Therefore, although the invention has been described based upon these example embodiments, it would be apparent to those of skill in the art that certain modifications, variations, and alternative constructions would be apparent, while remaining within the spirit and scope of example embodiments. Although the above embodiments refer to 5G NR and LTE technology, the above embodiments may also apply to any other present or future 3GPP technology, such as LTE-advanced, and/or fourth generation, 4G, technology.

### Partial Glossary

3GPP 3^{rd} Generation Partnership Project
4G 4^{th} Generation Wireless Technology
5G 5^{th} Generation Wireless Technology
CA Carrier Aggregation
CG Configured Grant
DC Dual Connectivity
DL Downlink
EDT Early Data Transmission
EMR Early Measurement Reporting
eNB Enhanced Node B
gNB 5G or NR Base Station
LTE Long Term Evolution
NR New Radio
NW
PCG
PUR
RA
Network
Pre-Configured Grant
Periodic Uplink Resources
Random Access
RACH Random Access Channel
RRC Radio Resource Control
SDT Small Data Transmission
UE User Equipment
UL Uplink
UP User Plane

1. A method, comprising:
receiving, from a network element, an early measurement reporting configuration;
receiving, from the network element, an indication of whether early measurement reporting during small data transmission is allowed; and
initiating small data transmission to the network element,
wherein the small data transmission comprises an early measurement reporting report when early measurement reporting is allowed.

2. The method according to claim 1, wherein the early measurement reporting report is included in one or more of initial small data transmission or subsequent small data transmission.

3.-18. (canceled)

19. An apparatus, comprising:
at least one processor; and
at least one memory comprising computer program code,
the at least one memory and the computer program code are configured, with the at least one processor to cause the apparatus at least to receive, from a network element, an early measurement reporting configuration;
receive, from the network element, an indication of whether early measurement reporting during small data transmission is allowed; and
initiate small data transmission to the network element,
wherein the small data transmission comprises an early measurement reporting report when early measurement reporting is allowed.

20. The apparatus according to claim 19, wherein the early measurement reporting report is included in one or more of initial small data transmission or subsequent small data transmission.

21. The apparatus according to claim 20, wherein the initial small data transmission comprises a radio resource control message for small data transmission.

22. The apparatus according to claim 20, wherein the subsequent small data transmission is performed after the one or more initial small data transmission.

23. The apparatus according to claim 19, wherein the at least one memory and the computer program code are further configured, with the at least one processor to cause the apparatus at least to:
perform measurements of neighbor cells or serving cells for reselection and early measurement reporting.

24. The apparatus according to claim 20, wherein initiation of the initial small data transmission comprises starting a small data transmission procedure by transmitting an initial small data transmission message.

25. The apparatus according to claim 24, wherein transmission of the early measurement reporting report is triggered when one or more signaling radio bearers are configured for small data transmission, or when early measurement reporting is configured for small data transmission.

26. The apparatus according to claim 24, wherein transmission of the early measurement reporting report is performed when one or more conditions are satisfied.

27. The apparatus according to claim 19, wherein the at least one memory and the computer program code are further configured, with the at least one processor to cause the apparatus at least to:
receive a request from the network element to send the early measurement reporting report.

28. The apparatus according to claim 21, wherein the radio resource control message prompts an integrity check for the small data transmission.

29. The apparatus according to claim 21, wherein the radio resource control message comprises an indication to stop early measurement reporting measurements.

30. An apparatus, comprising:
at least one processor; and
at least one memory comprising computer program code,
the at least one memory and the computer program code are configured, with the at least one processor to cause the apparatus at least to
transmit an early measurement reporting configuration;
transmit, to the user equipment an indication of whether early measurement reporting during small data transmission is allowed; and
receive a small data transmission from the user equipment,
wherein the small data transmission comprises an early measurement reporting report when early measurement reporting is allowed.

31. The apparatus according to claim 30, wherein the early measurement reporting report is included in one or more initial small data transmission or subsequent small data transmission.

32. The apparatus according to claim 31, wherein the initial small data transmission comprises a radio resource control message for small data transmission.

33. The apparatus according to claim 31, wherein the subsequent small data transmission is performed after the one or more initial small data transmission.

34. The apparatus according to claim 30, wherein the at least one memory and the computer program code are further configured, with the at least one processor to cause the apparatus at least to:
transmit a request to the user equipment requesting a small data transmission report.

35. The apparatus according to claim 32, wherein the radio resource control message prompts an integrity check for the small data transmission.

36. The apparatus according to claim 32, wherein the radio resource control message comprises an indication to stop early measurement reporting measurements.

37.-56. (canceled)
